(19) United States
(12) Patent Application Publication
(10) Pub. No.: US 2009/0298544 A1
(43) Pub. Date: Dec. 3, 2009

(54) SOFTWARE DEFINED BASE STATION

(75) Inventor: Sujai Karampuri, Karnataka (IN)

Correspondence Address: SCHWEGMAN, LUNDBERG & WOESSNER, P.A., P.O. BOX 2938, MINNEAPOLIS, MN, 55402, US

(73) Assignee: Sloka Telecom Pvt. Ltd., Indira Nagar (IN)

(21) Appl. No.: 12/541,336

(22) Filed: Aug. 14, 2009

Related U.S. Application Data
(63) Continuation of application No. PCT/IN2008/000091, filed on Feb. 15, 2008.

(51) Int. Cl. H04M 1/00; G06F 3/00

(52) U.S. Cl. 455/561; 719/328

(57) ABSTRACT

A system of base station includes a common controller platform to integrate a controller specific softwares of at least two technologies, a common transport platform to integrate a transport specific softwares of at least two technologies, a common base station software to interface with the common controller platform and the common transport platform, a generic hardware to execute the common controller platform and the common transport platform, and a plurality of hardware specific API to interface and communicate between the common software base station and the generic hardware. The common base station software includes, a common controller interface module to generate communication between the plurality of hardware specific API and the common controller platform, and a common transport interface module to generate communication between the plurality of hardware specific API and the common transport platform.

### RELATED APPLICATIONS

This application is a continuation under 35 U.S.C. 111(a) of PCT/IN2008/000091, filed Feb. 15, 2008 and published as WO 2008/099425 A2 on Aug. 21, 2008, which claimed priority under U.S.C. 119 to India Patent Application No. 318/CHE/2007, filed Feb. 16, 2007, which applications and publication are incorporated herein by reference and made a part hereof.

### BACKGROUND

1. Technical Field

The embodiments herein generally relate to wireless communication and more particularly to a software defined base station.

2. Description of the Related Art

A base station is a hardware device that works as a communicating entity with multi-channel two-way radio front-end in a mobile communication network. The base station may work as a representative of one or more network service (e.g., mobile communication service, internet service) providers, as a central radio transmitter/receiver that maintains communications with wireless devices (e.g., mobile phones, radio telephone sets) within a given range. There may be several base stations installed in a particular geographical area (e.g., a town, city, state). Each base station may broadcast a signal to a limited range due to having limited signal strength. The range may be determined by a coverage area of the base station.

The coverage area is the maximum distance of a subscriber's device from the base station that can completely sense the signal broadcasted by the base station. A particular geographical area may be divided into several regions, termed as cells. A cell may contain one or more base stations. Also, each base station may connect a limited number of subscriber devices to the network service provider. The number of subscriber devices is termed as the capacity of the base station.

FIG. 1 is a block diagram illustrating the architecture of a conventional base station 100 having a separate baseband unit 102, a control unit 104, a transport unit 106, and a radio unit 108. The base band unit 102 may involve a combination of Application Specific Integrated Circuit (ASIC) or Field-Programmable Gate Array (FPGA). The controller unit 104 may use a hardware board with various peripherals and customer network processors. The transport unit 106 may use another piece of hardware for providing various types of interfaces to a network, and the radio unit 108 may be a combination of various hardware pieces such as a digital section, mixed section, analog section, power amplifiers and low-noise amplifier (LNA). The conventional base station also includes an antenna 110 and an external network 112. The external network 112 may be a remote server located at a distance from the base station.

Since each of the units (e.g., the base band 102, the control unit 104) is built as an independent piece of hardware, the resulting base station 100 is large in size, intensive in hardware requirements, and expensive. Further, a network service provider may want to provide one or more services for multiple technologies (e.g., WiMAX, WCDMA, GSM, etc.). However, conventional base stations (e.g., the conventional base station 100) work only for a single technology (e.g., only WCDMA). Hence the service provider may have to install several base stations, one for each technology to increase the capacity and/or cover the frequency of operation.

One common architecture that addresses this problem is to implement some of the functionality in software. This gives design flexibility. It enables service providers to support multiple technologies more easily and at a lower cost. However, current solutions are inadequate because they are limited to transceiver architectures. This would include the radio front-end and the baseband. They do not consider other parts of a base station that remain fixed and inflexible.

The extent of flexibility introduced by existing Software Defined Radio architectures is limited to radio and some aspects of baseband. Such architectures are not fully configurable in the sense of flexible design, component reuse and cost savings. For example, while it may be possible to change baseband software from WCDMA to GSM, there is duplication of components for the radio. Components are enabled or disabled based on the current mode of operation. Components remain specific to a technology. Components are not reused in such architectures.

Base stations are a major component of network deployments of wireless systems (e.g., cellular, last-mile access). With increasing subscriber density and increasing frequency of operation, cell sizes continue to shrink, resulting in increase in the number of base stations installed in a geographic region. With this increase in the number of installed base stations, the high cost of conventional base stations compounds capital expenditure and operating expenditure for operators. Also the maintenance (e.g., upgrade, troubleshooting) costs are high since a service man may have to travel to visit each base station for maintenance work. Further, design, development, implementation and testing times are high due to long hardware cycles resulting in a large time-to-market.

### SUMMARY

Accordingly, there remains a need for a base station to increase overall network capacity with ease of deployment, management, upgrade, maintenance and provide cost-effective and flexible solutions that can accommodate multiple technologies across a wider frequency band of operation.

In view of the foregoing, an embodiment herein provides a system of base station includes a common controller platform to integrate a controller specific softwares of at least one technology, a common transport platform to integrate a transport specific softwares of at least one technology, a common base station software to interface with the common controller platform and the common transport platform, a generic hardware to execute the common controller platform and the common transport platform, and a plurality of hardware specific API to interface and communicate between the common software base station and the generic hardware. The common base station software a common controller interface module to generate communication between the plurality of hardware specific API and the common controller platform, and a common transport interface module to generate communication between the plurality of hardware specific API and the common transport platform.

A common baseband platform may integrate a baseband specific softwares of at least one technology. The common controller platform may integrate a controller specific softwares of at least one technology. The technology is at least one of a WiMAX, a GSM, or a CDMA. The common controller platform and the common transport platform are agnostic to the plurality of hardware specific API. The generic hardware includes at least one of at least one Field Programmable Gate Array (FPGA) or at least one DSP unit. The controller specific softwares is based on at least one of a WiMAX protocol, a UMTS protocol or a GSM protocol and the transport specific softwares is based on at least one of a OC-3, a optic fiber, a E1/T1, or an Ethernet. The common base station software further includes an upgrade module to upgrade the controller specific softwares, or the transport specific softwares based on a communication from a remote server.

In another aspect, a method for operating a software defined base station, the software defined base station includes a common controller platform to integrate a controller specific softwares of a plurality of technologies, a common baseband platform to integrate a baseband specific softwares of a plurality of technologies, a common base station software to interface with the common controller platform and the common baseband platform, a generic hardware to execute the common controller platform and the common baseband platform, and a plurality of hardware specific APIs to interface and communicate between the common base station software and the generic hardware. The method includes coordinating an interaction between a common controller platform and a common baseband platform, and executing the common controller platform and the common baseband platform through a plurality of hardware specific APIs.

The common controller platform and the common transport platform are agnostic to the plurality of hardware specific APIs. The plurality of technologies is at least one of a WiMAX, a GSM, or a CDMA. The generic hardware includes at least one of at least one Field Programmable Gate Array (FPGA) or at least one DSP unit. The common base station software communicates with the generic hardware using at least one of the plurality of hardware specific application programming interfaces (APIs). The common baseband platform may integrate a baseband specific softwares of at least one technology and the common controller platform may integrate a controller specific softwares of at least one technology.

In yet another aspect, a program storage device readable by computer, tangibly embodying a program of instructions executable by the computer to perform a method of configuring a common base station software in a base station, the base station includes a common controller platform to integrate a controller specific softwares of a plurality of technologies, a common baseband platform to integrate a baseband specific softwares of a plurality of technologies, a common base station software to interface with the common controller platform and the common baseband platform, a generic hardware to execute the common controller platform and the common baseband platform, and a plurality of hardware specific API to interface and communicate between the common base station software and the generic hardware. The common base station software further includes a common controller interface module to generate communication between the plurality of hardware specific API and the common controller platform, and a common baseband interface module to generate communication between the plurality of hardware specific API and the common baseband platform.

The method includes coordinating an interaction between a common controller platform and a common baseband platform, and executing the common controller platform and the common baseband platform through a plurality of hardware specific APIs. The common controller platform and the common baseband platform are agnostic to the plurality of hardware specific APIs. The plurality of technologies is at least one of a WiMAX, a GSM, or a CDMA and the generic hardware includes at least one of a Field Programmable Gate Array (FPGA) or at least one DSP unit. The controller specific softwares is based on at least one of a WiMAX protocol, a UMTS protocol or a GSM protocol and the baseband specific softwares is based on at least one of a modulation, a voice processing, a data processing, a cipher, or an interleaving. The common base station software communicates with the generic hardware using at least one of the plurality of hardware specific application programming interfaces (APIs). The common base station software further includes an upgrade module to upgrade the controller specific softwares, or the baseband specific softwares based on a communication from a remote server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating the architecture of a conventional base station having a separate base band unit, a control unit, a transport unit and a radio unit, according to an embodiment herein;

FIG. 2 illustrates a software defined base station communicating with an enterprise, a small office, a home office, and a residential area through a network and/or an antenna, according to one embodiment herein;

FIG. 3 is a block diagram illustrating the architecture of the software defined base station of FIG. 2 having a generic hardware, a plurality of hardware specific APIs, a common base station software, a common controller platform, a common transport platform, a common radio platform, a common baseband platform, controller specific softwares, transport specific softwares, radio specific softwares and baseband specific softwares, according to one embodiment herein;

FIG. 4 is an exploded view of the common base station software of FIG. 3 having a common controller interface module, a common transport interface module, a common radio interface module, a common base band interface module, an upgrade module, and a hardware interface module, according to one embodiment herein;

FIG. 5 illustrates an exploded view of the generic hardware, the common base station software, and the hardware specific API of the software defined based station of FIG. 3, according to an embodiment herein;

FIG. 6 illustrates an exploded view of the common controller platform, the common transport platform, the common radio platform, the common baseband platform, the controller specific softwares, the transport specific softwares, the radio specific softwares and the baseband specific softwares of the software defined based station of FIG. 3, according to an embodiment herein;

FIG. 7 illustrates the exploded view of the generic hardware, the common base station software, and the hardware specific API of FIG. 5 for a WiMAX base station with Ethernet transport connectivity, according to an embodiment herein;

FIG. 8 illustrates the exploded view of the common controller platform, the common transport platform, the common radio platform, the common baseband platform, the controller specific softwares, the transport specific softwares, the radio specific softwares and the baseband specific softwares of FIG. 6, according to an embodiment herein;

FIG. 9 is a flow diagram illustrating a method for operating a software defined base station according to an embodiment herein; and

FIG. 10 is a schematic diagram illustrating a computer system according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

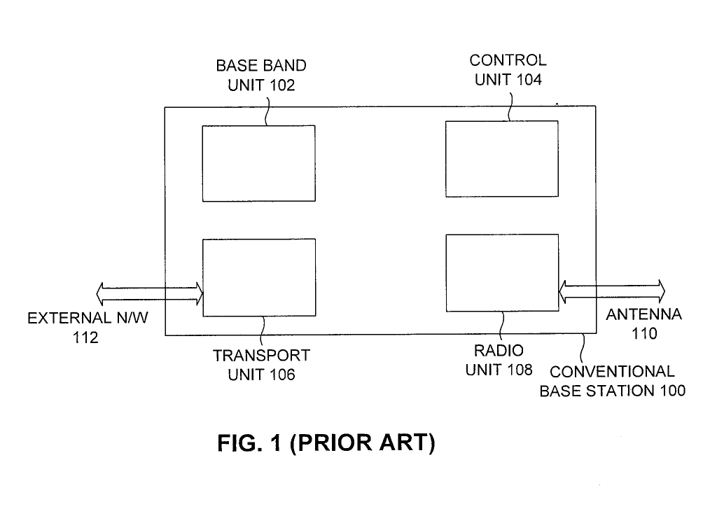

As mentioned, there remains a need for a base station to increase overall network capacity with ease of deployment, management, upgrade, maintenance and provide cost-effective and flexible solutions that can accommodate multiple technologies across a wider frequency band of operation. The embodiments herein achieve this by providing a system of base station includes a common controller platform 314 to integrate a controller specific softwares 322 of at least one technology, a common transport platform 316 to integrate a transport specific softwares 324 of at least one technology, a common base station software 312 to interface with the common controller platform 314 and the common transport platform 316, a generic hardware 302 to execute the common controller platform 314 and the common transport platform 316, and a plurality of hardware specific API 304-310 to interface and communicate between the common software base station 312 and the generic hardware 302. The common base station software 312 includes a common controller interface module 400 to generate communication between the plurality of hardware specific API 304-310 and the common controller platform 314, and a common transport interface module 402 to generate communication between the plurality of hardware specific API 304-310 and the common transport platform 316. Referring now to the drawings, and more particularly to FIGS. 1 through 10, where similar reference characters denote corresponding features consistently throughout the figures, there are shown preferred embodiments.

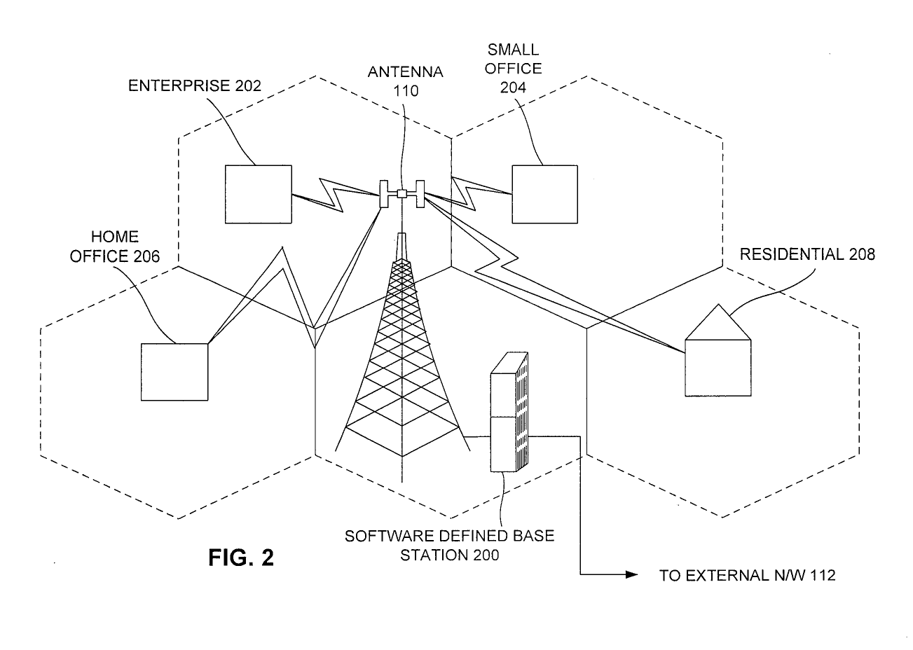

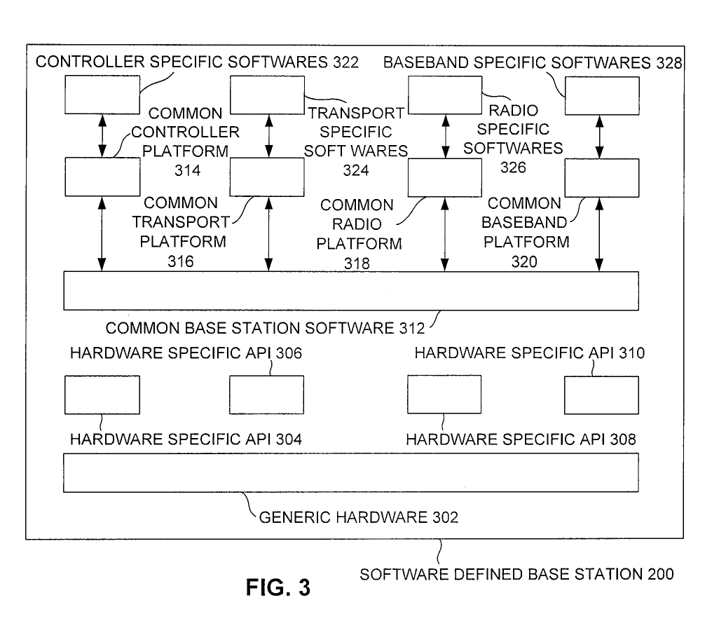

FIG. 2 illustrates a software defined base station 200 communicating with an enterprise 202, a small office 204, a home office 206, and a residential area 208 through the network 112 and/or the antenna 110, according to one embodiment. The software defined base station 200 may be placed along side the antenna 110, and may provide one or more wireless technologies (e.g., 3G UMTS, WiMAX, CDMA, CDMA2000, GSM, GPRS, EDGE) to the enterprise 202, the small office 204, the home office 206, and/or the residential area 208 through the antenna 110 and/or the external network 112. In the software defined base station 200, the controller unit, the transport unit, the radio unit, and the baseband unit may be completely software defined (e.g., using the controller specific softwares 322, the transport specific softwares 324, the radio specific softwares 326 and the baseband specific softwares 328 as shown in FIG. 3), and the software defined base station 200 may be built entirely using generic hardware (e.g., the generic hardware 300 as shown in FIG. 3), such as programmable chipsets.

Hence the software defined base station 200 may be extremely compact (e.g., 3-5 Kg) and cost effective (e.g., can be built at ⅛^{th} to 1/10^{th} the cost of the conventional base station 100). A service provider may roll out multiple technologies (e.g., 3G UMTS, WiMAX) using the same base station. The software defined base station 200 may allow for quicker design, development, implementation and testing, since software changes can be made much faster than any hardware changes and software cycles are shorter than hardware cycles. The software defined base station 200 can be upgraded and tested remotely eliminating the need for a service man to drive to each base station, and allow for extremely short downtime periods without affecting the traffic on the network.

FIG. 3 is a block diagram illustrating the architecture of the software defined base station 200 of FIG. 2 having a generic hardware 302, a hardware specific API 304, a hardware specific API 306, a hardware specific API 308, a hardware specific API 310, a common base station software 312, a common controller platform 314, a common transport platform 316, a common radio platform 318, a common baseband platform 320, controller specific softwares 322, transport specific softwares 324, radio specific softwares 326 and baseband specific softwares 328, according to one embodiment. The generic hardware 302 may be at a first base level (e.g., as illustrated in FIG. 3), and may include one or more hardware units (e.g., not shown in FIG. 3).

The generic hardware 302 may execute various methods, processes and/or algorithms on software of at least one technology (e.g., the common base station software 312, the common controller platform 314, and/or the controller specific softwares 322) through the hardware specific APIs 304-310. The hardware specific APIs 304, 306, 308 and 310 may at a second level above the generic hardware 302 layer, and may correspond to each hardware unit in the generic hardware 302. The common base station software 312 may be at a third level, above the hardware specific APIs 304-310, and may link the hardware specific APIs with a fourth level which may include the common controller platform 314, the common transport platform 316, the common radio platform 318, and the common baseband platform 320.

The common controller platform 314, the common transport platform 316, the common radio platform 318, and the common baseband platform 320 may each interact with the controller specific softwares 322, the transport specific softwares 324, the radio specific softwares 326 and the baseband specific softwares 328 respectively, which are at a fifth level. The generic hardware 302 is independent of the technology or functionality and may implement any technology and/or functionality such as WiMAX, a gateway network controller, or GSM. The generic hardware 302 may be made of FPGA or DSP chips that are programmable and reconfigurable, and may be produced in mass volume.

The generic hardware 302 may support all functionalities for each of the software components at subsequent levels (e.g., each of the controller specific softwares 322, each of the transport specific softwares 324) and may implement functionalities according to the specific software that is loaded. The hardware units in the generic hardware 302 may interact with corresponding hardware specific APIs such as the hardware specific API 304, the hardware specific API 306, the hardware specific API 308 and the hardware specific API 310. The common base station software 312 may be common to the entire software defined base station 200, and includes software modules for multiple technologies (e.g., WiMAX, GSM, and CDMA). The common base station software 312 may coordinate interaction between software components (e.g., between the common controller platform 314 and the common transport platform 316) at subsequent levels, and include modules and/or information (e.g., a subscriber information) that is common to the software components.

The common base station software 312 may interface with software components at subsequent levels, and execute them through the hardware APIs that correspond to hardware units in the generic hardware 302. The software components residing at levels subsequent to the common base station software 312 may be agnostic to the hardware executing them and thus the software components (e.g., the common controller platform 314, the common transport platform 316, the transport specific softwares 324) and the hardware (e.g., the generic hardware 302), may be designed independently, and integrated by the common base station software 312. Also, any platform (e.g., the common controller platform 314, the common transport platform 316, the common radio platform 318, the common baseband platform 320) and/or component can be altered and/or replaced by another platform and/or component at any point of time.

The common controller platform 314 may integrate the plurality of controller specific softwares (e.g., MAC, call processing) 322 of any single technology (e.g., GSM), as well as the plurality of controller specific softwares 322 of multiple technologies (e.g., WiMAX protocol, UMTS protocol, GSM protocol). The controller specific softwares 322 of one or more technologies may interact with each other via the common controller platform 314. The controller specific softwares 322 may be developed independent of each other, and then integrated by the common controller platform 314.

The common transport platform 316 may integrate the plurality of transport specific softwares (e.g., OC-3, optic fiber, E1/T1, Ethernet) 324 of any single technology, as well as the plurality of controller specific softwares 322 of multiple technologies. The transport specific softwares 324 of one or more technologies may interact with each other via the common transport platform 316. The transport specific softwares 322 may be developed independent of each other, and then integrated by the common transport platform 316. The generic hardware 302 may support all transport specific softwares 322 such as OC-3, E1/T1, and Ethernet but the functionality of a specific software (e.g., Ethernet) cannot be achieved without the corresponding software being loaded (e.g., if only OC-1 and E1/T1 modules are present or plugged in, and Ethernet software is not, OC-1 and E1/T1 functionality can be implemented but not Ethernet).

The common radio platform 318 may integrate the plurality of radio specific softwares 326 of any single technology, as well as the plurality of radio specific softwares 326 of multiple technologies (e.g., GSM radio, CDMA radio). The radio specific softwares 326 of one or more technologies may interact with each other via the common radio platform 318. The radio specific softwares 326 may be developed independent of each other, and then integrated by the common radio platform 318.

The common baseband platform 320 may integrate the plurality of baseband specific softwares (e.g., modulation, voice processing, data processing, cipher, interleaving) 328 of any single technology (e.g., GSM), as well as the plurality of baseband specific softwares 328 of multiple technologies (e.g., GSM base band which is GMSK modulation, WCDMA baseband which is BPSK, QPSK or QAM modulation, WiMAX base band which is based on OFDM modulation). The baseband specific softwares 328 of one or more technologies may interact with each other via the common baseband platform 320. The baseband specific softwares 328 may be developed independent of each other, and then integrated by the common baseband platform 320.

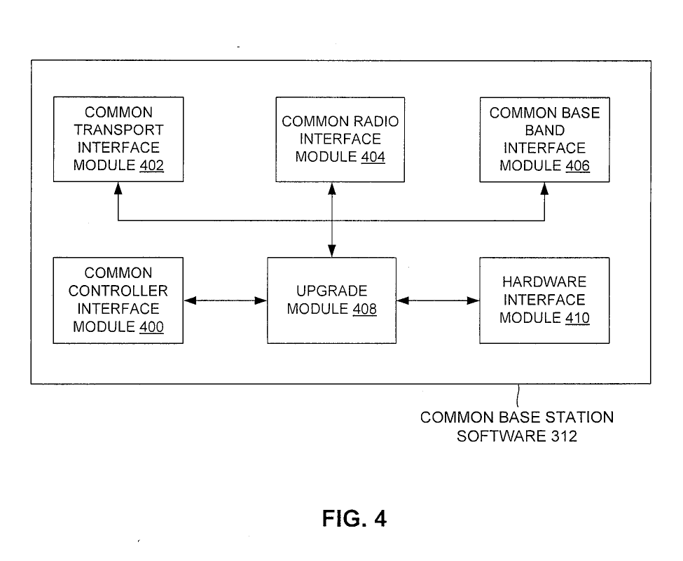

FIG. 4 is an exploded view of the common base station software 312 having a common controller interface module 400, a common transport interface module 402, a common radio interface module 404, a common base band interface module 406, an upgrade module 408, and a hardware interface module 410 according to one embodiment herein. The common controller interface module 400 may generate communication between a plurality of hardware specific API 304-310 and the common controller platform 314. The common transport interface module 402 may generate communication between the plurality of hardware specific API 304-310 and the common transport platform 316.

The common radio interface module 404 may generate communication between the plurality of hardware specific API 304-310 and the common radio platform 318. The common base band interface module 406 may generate communication between the plurality of hardware specific API 304-310 and the common base band platform 320. The upgrade module 408 may upgrade and/or update a plurality of specific softwares. The specific softwares may include a controller specific softwares, a radio specific softwares, a transport specific softwares and a baseband specific softwares. In one embodiment, the upgrade module 408 may test the plurality of specific softwares. The hardware interface module 410 may generate communication to the plurality of hardware specific API 304-310.

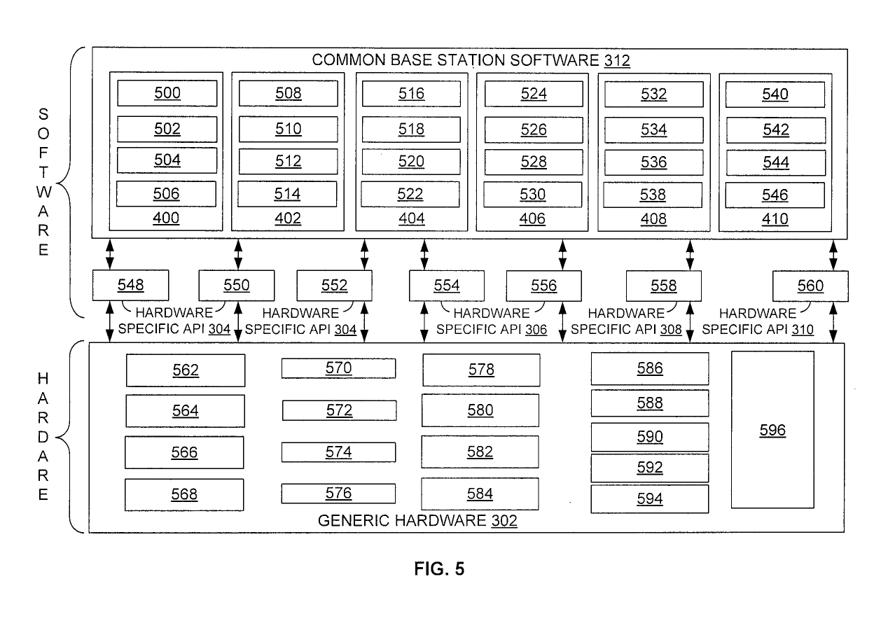

FIG. 5 illustrates an exploded view of the generic hardware 302, the common base station software 312, and the hardware specific API 304-310 of the software defined based station 200 of FIG. 3, according to an embodiment herein. The API 304-310 allows the common base station software 312 to configure the generic hardware 302 and interact with the same hardware. The generic hardware 302 may have components like a FPGA 570, a ROM 574, a power save module 580, LED circuitry 584, ATM interface 586, T1/E1 interface 590, and OC3 interface 592. Media processor 562 performs signal processing and algorithmic computations. The media processor 562 may be a DSP (digital signal processor).

The network processor 566 is a generic processor that runs control and management software, and protocol software. The media processor 562 and the network processor 566 are interfaced by a Shared Dual-port RAM 564 through which they exchange data and messages. The RF module 568 implements the RF transceiver chain including A/D and D/A conversions. The memory modules may include a FPGA 570, a RAM 572, the ROM 574 and a flash memory 576. In one embodiment, each memory type is suited for specific purposes and used as appropriate. The timer module 578 implements timer at hardware level. The timer module 578 includes a watchdog timer and reset functionality that keeps a check on the network processor 566.

The power save module 580 is a component to optimize on battery power. The power save module 580 is both hardware and software controlled. The clock circuitry 582 handles clock translations for different parts of the system. The LED circuitry 584 indicates a display and diagnostic interface to the user. Different interfaces are part of the hardware. They may be operational mutually exclusively or in applicable cases configured to operate in parallel. The ATM interface 586 handles ATM connections. The Ethernet interface 588 handles Ethernet connections. The T1/E1 interface 590 handles T1/E1 connections. The OC3 interface 592 enables optical fibre transport. The JTAG interface 594 provides the ability for debug and diagnostics. These interfaces are controlled by programmable input/output drivers 596.

The hardware specific APIs 304-310 provide the functionality to interact with the hardware. The media processor API 548 provides the ability to configure the media processor 562. The network processor API 550 provides an interface to configure and control the network processor 566. The RF module API 552 enables control of RF module 568. The FPGA and the memory API 554 enables configuration of the FGPA 570, the RAM 572, the ROM 574, the flash memory 576. The timer module 578, the power save module 580 and the other circuitry API 556 enable configuration of the timer module 578, the power save module 580, the clock circuitry 582, and the LED circuitry 584. The interface API 558 enables configuration of the ATM interface 586, Ethernet interface 588, the T1/E1 interface 590, the OC3 interface 592, and the JTAG interface 594. The I/O driver API 560 enables the programming and control of the I/O drivers 596.

The common controller interface module 400 includes a hardware diagnostic unit 500, an operation and maintenance unit 502, a measurement unit 504, and a call processing unit 506. A hardware diagnostic unit may perform diagnostic operations of the HW. This interaction may involve all of the hardware API 548-560. The OAM (Operation and Maintenance) API 502 performs the relevant functions. The measurement unit 504 performs relevant measurement of resource usage and loading. The call processing 506 initiates a call processing without involving specifics of the technology.

The common transport interface module 402 includes a data handler 508, a load balancer 510, a traffic monitor 512, and a hardware interface manager 514. The data handler 508 handles data that is transported and involves translation and relay of data from one protocol layer to another. The load balancer 510 balances the load for the transport functionality. The traffic monitor 512 monitors traffic and enables collection of performance metrics. The hardware interface manager 514 involves the use of interface API 558 and 560 for management of the different interfaces.

The common radio interface module 404 includes a measurement unit 516, a gain control function 518, a band setting function 520, and a frequency manager 522. The measurement unit 516 controls hardware components that facilitate in RF measurements such as RSSI (Received Signal Strength Indicator) and RSCP (Received Signal Code Power). The gain control function 518 controls the gain of RF module 568 through API 552. The band setting function 520 is responsible for setting the band according to the mode of operation (GSM, WDCMA, WiMAX, etc.). The frequency manager 522 sets and manages the carrier frequency. The common baseband interface module 406 includes a quality feedback unit 524, hardware delegate function 526, a buffer control 528, and a coding and modulation 530. The quality feedback unit 524 collects channel quality statistics (such as bit error rate) and sends to the common baseband platform 320.

This information assists in deciding if modulation or coding needs to be changed. A hardware delegate function 526 is responsible for performing a function in a hardware component. This invokes the API 548, 550 and 554. A buffer control 528 manages soft buffer used during channel decoding or interleaving. This involves memory control using API 554. The coding and modulation 530 provides basic functionality to access relevant hardware API for the purpose of coding and modulation.

The upgrade module 408 includes a controller upgrade 532, a transport upgrade 534, a radio upgrade, and a baseband upgrade 538. These components may access memory API 554 for minimal write to flash memory 576. The controller upgrade 532 is used for upgrading the common controller interface module 400, the common controller platform 314, and the controller specific softwares 322. The transport upgrade 534 is used for upgrading the common transport interface module 402, the common transport platform 316, and the transport specific softwares 324. The radio upgrade 536 is used for upgrading the common radio interface module 404, the common radio platform 318, and the radio specific softwares 326. The baseband upgrade 538 is used for upgrading the common baseband interface module 406, the common baseband platform 320, and the baseband specific softwares 328.

The hardware interface module 410 includes a coordination function 540, event handlers 542, call back functions 544, and a hardware access scheduler 546. The coordination function 540 coordinates all access to the generic hardware 302 to ensure a smooth operation. This avoids unnecessary contention and enables pipelines access. The event handlers 542 handle events that come back from the hardware to be handled in software. The events may then be passed to other modules within the common base station software 312. The call back functions 544 enable the software to call back a function to be performed by the specific hardware. The scheduler 546 priorities to the hardware and relates to the coordination function 540.

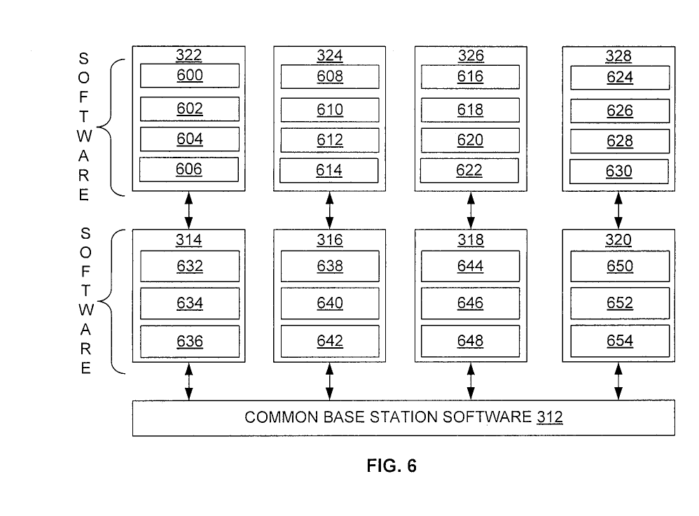

FIG. 6 illustrates an exploded view the common controller platform 314, the common transport platform 316, the common radio platform 318, the common baseband platform 320, the controller specific softwares 322, the transport specific softwares 324, the radio specific softwares 326 and the baseband specific softwares 328 of the software defined based station 200 of FIG. 3, according to an embodiment herein. The specific softwares 322-328 interface to the common base station software 322 via their respective common platforms. The controller specific softwares 322 include a GSM MAC processing 600, a WCDMA MAC processing 602, a WiMAX processing 604, and a call processing 606. The technology specific MAC processing is implemented in the GSM MAC processing 600, the WCDMA MAC processing 602 and the WiMAX processing 604 for GSM, WCDMA and WiMAX respectively. The call processing 606 may enable to process a call. The common controller platform 314 includes common MAC processing 632, a admission controller 634, and a scheduler 636. The common MAC processing 632 contains all MAC processing that is common across technologies (WCDMA, WiMAX or GSM). The admission control 634 decides if it is permissible to allow more calls into the system. The scheduler 636 schedules calls and access and works closely with common MAC processing 632. The transport specific softwares 324 include an T1/E1 software 608, a OC3 software 610, an ATM software 612, and a Ethernet software 614. The T1/E1 software 608 contains the software to drive transport over T1/E1. Similarly, the OC3 software 610, the ATM software 612 and the Ethernet software 614 provide driver software for transport over OC3, ATM and Ethernet respectively.

The common transport platform 316 includes an ATM-Ethernet interworking 638, the T1/E1 interworking 640, and the configuration manager 642. The ATM-Ethernet interworking 638 provides the functionality to transport ATM over Ethernet. If there is a requirement to support Ethernet over ATM, this component would be upgraded. The T1/E1 interworking 640 translates between the transports mechanisms. The configuration manager 642 manages the configuration of drivers and interfaces for transport by using the hardware interface manager 514. The radio specific softwares 326 include a GSM module 616, a WCDMA module 618, a TD-SCDMA module 620, and a WiMAX module 622. The modules 616-622 provide radio modules for GSM, WCDMA, TD-SCDMA and WiMAX respectively.

The common radio platform 318 includes GSM-WCDMA interworking 644, a band activation unit 646, and a low RF unit 648. The GSM-WCDMA interworking 644 handles the switching between the two technologies which may be triggered in the case of a handover. The band activation unit 646 is responsible for activating the correct band. Each radio technology operates in a different band. Some radio technologies may generally share in common low RF bands. This common part is implemented in the low RF unit 648. The baseband specific softwares 328 includes a GSM coding and modulation 624, a WCDMA coding and modulation 626, a WiMAX coding and modulation 628, and a voice processing 630. The coding and modulation for different standards is handled by specific softwares. The coding and modulations 624-628 perform for standards GSM, WCDMA and WiMAX respectively. The voice processing unit 630 handles voice commands.

The common baseband platform 320 includes a common interleaver 650, a viterbi decoding unit 652, and a modulation control unit 654. The common interleaver 650 abstracts interleaving functionality that is common across all radio standards. The modulation control unit 654 controls modulation without specifics and may use metrics provided by quality feedback unit 524 to decide if a change of modulation is desired.

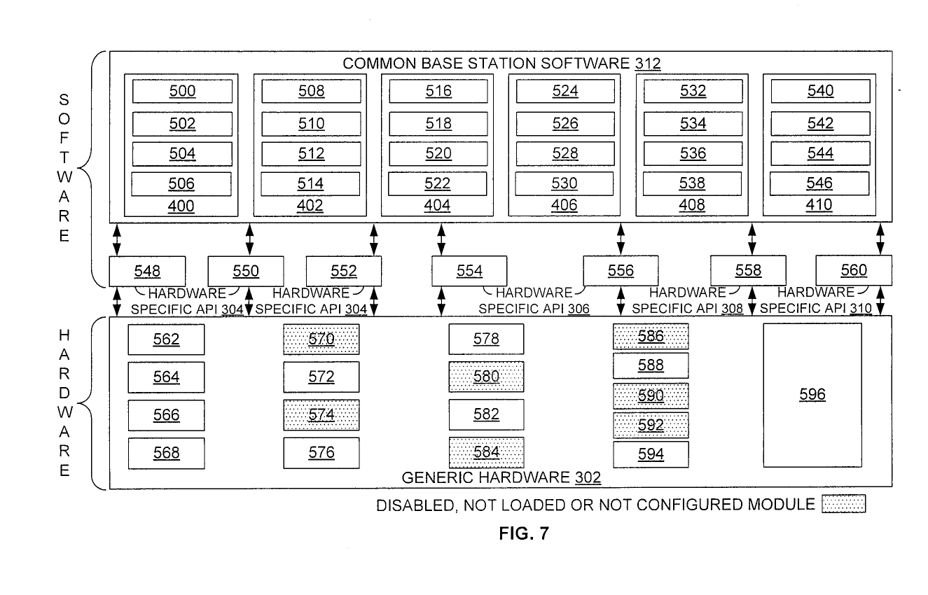

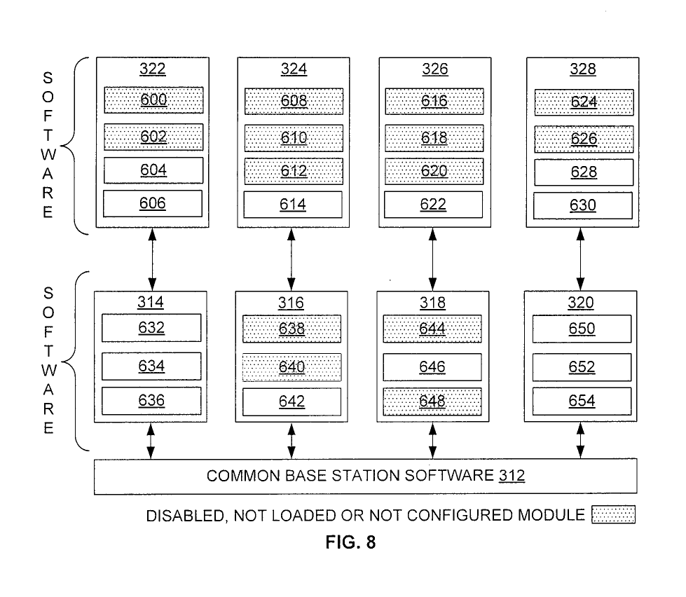

FIG. 7 illustrates the exploded view of the generic hardware 302, the common base station software 312, and the hardware specific API 304-310 of FIG. 5 for a WiMAX base station with Ethernet transport connectivity, according to an embodiment herein. FIG. 8 illustrates the exploded view of the common controller platform 314, the common transport platform 316, the common radio platform 318, the common baseband platform 320, the controller specific softwares 322, the transport specific softwares 324, the radio specific softwares 326 and the baseband specific softwares 328 of FIG. 6, according to an embodiment herein. FIG. 7 illustrates the FPGA 570, the ROM 574, the power save module 580, the LED circuitry 584, the ATM interface 586, the T1/E1 interface 590 and the OC3 interface 592. Such omissions may generally take place when the base station is manufactured in high volumes. If a readily available hardware already has some of the modules, they may be disabled or not configured from software.

These modules may also be required for the operation of any other technology (GSM, WCDMA) using any other transport (ATM, T1/E1). This implies the generic nature of the modules and their high degree of configurable behaviour. FIG. 8 illustrates the GSM MAC processing 600, the WCDMA MAC processing 602, the T1/E1 software 608, the OC3 software 610, the ATM software 612, the ATM-Ethernet Interworking 638, the T1/E1/interworking 640, the GSM module 616, the WCDMA module 618, the TD-SCDMA module 620, the GSM-WCDMA interworking 644, the low RF unit 648, the GSM coding and modulation 624, the WCDMA coding and modulation 626.

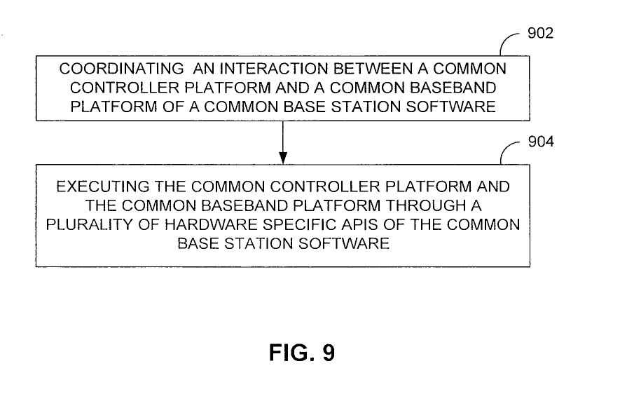

FIG. 9 is a flow diagram illustrating a method for operating a software defined base station according to an embodiment herein, wherein the method comprises: coordinating (902) an interaction between a common controller platform 314 and a common baseband platform 320 of a common base station software 312, and executing (904) the common controller platform 314 and the common baseband platform 320 through a plurality of hardware specific APIs 304-308 of the common base station software 312.

In step 902, an interaction is coordinated between the common controller platform 314 and the common baseband platform 320 of the common base station software 312. In step 904, the common controller platform 314 and the common baseband platform 320 are executed through the plurality of hardware specific APIs 304-310 of the common base station software 312.

The embodiments herein include both hardware and software elements. Preferably, the software embodiments include, but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

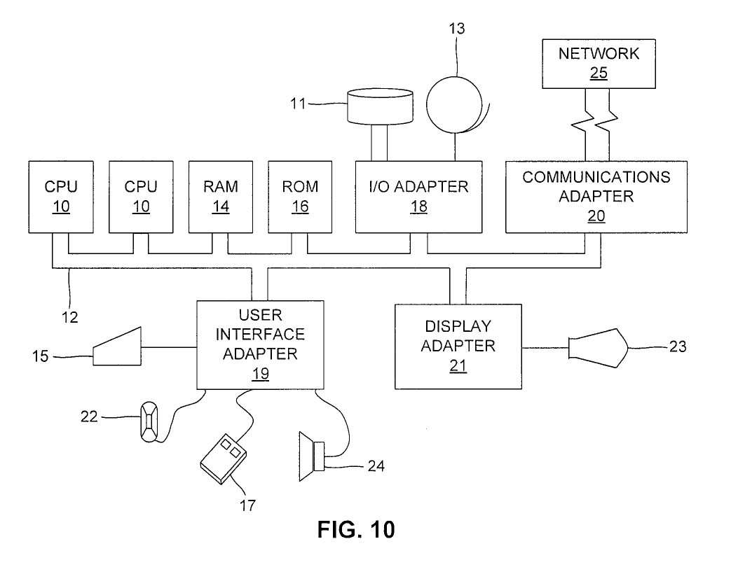

A representative hardware environment for practicing the embodiments herein is depicted in FIG. 10. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The software defined base station 200 is capable of supporting multiple standards with a high degree of configurability. Such a support encompasses radio, baseband, transport and controller components of the base station. The architecture is based on commonly available generic hardware that can be accessed by the common base station software via hardware APIs. The common base station software further facilitates the interaction between the generic hardware and higher level software modules that are common across technologies or specific to a particular technology. Flexibility is achieved by this modular architecture in which intelligent partitioning between software and hardware is enabled. It is also achieved by incorporating the distinction between common software modules and specific software modules which the hardware itself is agnostic to the actual software that runs on it.

FIG. 9 is a flow diagram illustrating a method for operating the software defined base station 200 according to an embodiment herein, wherein the method comprises: coordinating (902) an interaction between a common controller platform 314 and a common baseband platform 320 of a common base station software 312, and executing (904) the common controller platform 314 and the common baseband platform 320 through a plurality of hardware specific APIs 304-310 of the common base station software 312.

In step 902, an interaction is coordinated between the common controller platform 314 and the common baseband platform 320 of the common base station software 312. In step 904, the common controller platform 314 and the common baseband platform 320 are executed through the plurality of hardware specific APIs 304-310 of the common base station software 312.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A base station system comprising:
a common controller platform configured to use at least two different controller-specific softwares respectively corresponding to different mobile communications technologies;
a common transport platform configured to use at least two different transport-specific softwares respectively corresponding to different communication network technologies;
a common base station software, configured to interface with the common controller platform and the common transport platform, the common base station software comprising:
a common controller interface module, configured to generate communication between a plurality of hardware-specific API and the common controller platform; and
a common transport interface module, configured to generate communication between a plurality of hardware specific API and the common transport platform;
a hardware platform that is hardware agnostic to the different mobile communications technologies and to the different communication network technologies, the hardware platform comprising memory and configured to execute the common controller platform and the common transport platform to facilitate base station communication with a mobile communication device; and
a plurality of software-defined hardware specific API configured to interface and communicate between the common base station software and the hardware platform.

2. The system of claim 1, wherein the common controller platform is configured to use at least two different controller-specific softwares respectively corresponding to different mobile communications technologies that include at least one of GSM, WCDMA, WiMAX, CDMA, UMTS, or LTE.

3. The system of claim 1, wherein the common transport platform is configured to use at least two different transport-specific softwares respectively corresponding to different communication network technologies that include at least one of OC-3, E1/T1, or Ethernet.

4. The system of claim 1, wherein the common controller platform and the common transport platform are agnostic to the plurality of software defined hardware specific API.

5. The system of claim 1, wherein the hardware platform comprises at least one programmable circuit that is software-configurable for use with at least one of a particular mobile communications technology or a particular communication network technology.

6. The system of claim 1, further comprising the at least two different controller-specific softwares respectively corresponding to different mobile communications technologies that include at least one of GSM, WCDMA, WiMAX, CDMA, UMTS, or LTE.

7. The system of claim 1, further comprising the at least two different transport-specific softwares respectively corresponding to different communication network technologies that include at least one of OC-3, E1/T1, or Ethernet.

8. The system of claim 1, further comprising at least one of (1) the at least two different controller-specific softwares or (2) the at least two different transport-specific softwares, and further comprising an upgrade module configured to upgrade, based on a communication from a remote server, at least one of (1) the at least two different controller-specific softwares or (2) the at least two different transport-specific softwares.

9. A method for operating a software defined base station, comprising:
using at least two different controller-specific softwares respectively corresponding to different mobile communications technologies at a common controller platform;
using at least two different transport-specific softwares respectively corresponding to different communication network technologies at a common transport platform;
interfacing the common controller platform with the common transport platform, using a common base station software comprising:
a common controller interface module, configured to generate communication between a plurality of hardware-specific API and the common controller platform; and
a common transport interface module, configured to generate communication between a plurality of hardware specific API and the common transport platform;
executing the common controller platform and the common transport platform using a hardware platform that is hardware agnostic to the different mobile communications technologies and to the different communication network technologies, the hardware platform comprising memory, to facilitate base station communication with a mobile communication device; and
using a plurality of software-defined hardware specific API, interfacing and communicating between the common base station software and the hardware platform.

10. The method of claim 9, wherein using at least two different controller-specific softwares respectively corresponding to different mobile communications technologies at a common controller platform comprises using at least one of GSM, WCDMA, WiMAX, CDMA, UMTS, or LTE.

11. The method of claim 9, wherein using at least two different transport-specific softwares respectively corresponding to different communication network technologies at a common transport platform comprises using at least one of OC-3, E1/T1, or Ethernet.

12. The method of claim 9, wherein the common controller platform and the common baseband platform are agnostic to the plurality of software defined hardware specific APIs.

13. The method of claim 9, wherein the executing the common controller platform and the common transport platform using a hardware platform comprises using at least one programmable circuit that is software-configurable for use with at least one of a particular mobile communications technology or a particular communication network technology.

14. A tangible program storage device, readable by a software-defined base station, comprising instructions performable to carry out a method for operating a software defined base station comprising:
using at least two different controller-specific softwares respectively corresponding to different mobile communications technologies at a common controller platform;
using at least two different transport-specific softwares respectively corresponding to different communication network technologies at a common transport platform;
interfacing the common controller platform with the common transport platform, using a common base station software comprising:
a common controller interface module, configured to generate communication between a plurality of hardware-specific API and the common controller platform; and
a common transport interface module, configured to generate communication between a plurality of hardware specific API and the common transport platform;
executing the common controller platform and the common transport platform using a hardware platform that is hardware agnostic to the different mobile communications technologies and to the different communication network technologies, the hardware platform comprising memory, to facilitate base station communication with a mobile communication device; and
using a plurality of software-defined hardware specific API, interfacing and communicating between the common base station software and the hardware platform.

15. The tangible program storage device of claim 14, comprising instructions performable to carry out the method for operating a software defined base station, wherein using at least two different controller-specific softwares respectively corresponding to different mobile communications technologies at a common controller platform comprises using at least one of GSM, WCDMA, WiMAX, CDMA, UMTS, or LTE.

16. The tangible program storage device of claim 14, comprising instructions performable to carry out the method for operating a software defined base station, wherein using at least two different transport-specific softwares respectively corresponding to different communication network technologies at a common transport platform comprises using at least one of OC-3, E1/T1, or Ethernet.

17. The tangible program storage device of claim 14, comprising instructions performable to carry out the method for operating a software defined base station, wherein the common controller platform and the common baseband platform are agnostic to the plurality of software defined hardware specific APIs.

18. The tangible program storage device of claim 14, comprising instructions performable to carry out the method for operating a software defined base station, wherein the executing the common controller platform and the common transport platform using a hardware platform comprises using at least one programmable circuit that is software-configurable for use with at least one of a particular mobile communications technology or a particular communication network technology.

19. The tangible program storage device of claim 14, comprising instructions performable to carry out the method for operating a software defined base station, wherein:
at least one of the controller-specific softwares is based on at least one of a WiMax protocol, a UMTS protocol or a GSM protocol; and
at least one of the baseband-specific softwares is based on at least one of a modulation, a voice processing, a data processing, a cipher, or an interleaving.

20. The tangible program storage device of claim 14, comprising instructions performable to carry out the method for operating a software defined base station, wherein the tangible program storage device is configured to be upgradeable with instructions based on a communication from a remote server.
